(19) United States
(12) Patent Application Publication
(10) Pub. No.: US 2024/0263041 A1
(43) Pub. Date: Aug. 8, 2024

(54) ADHESIVE AND ADHERING METHOD

(71) Applicant: DISCO CORPORATION, Tokyo (JP)

(72) Inventor: Makoto SHIMOTANI, Tokyo (JP)

(21) Appl. No.: 18/429,574

(22) Filed: Feb. 1, 2024

(30) Foreign Application Priority Data
Feb. 3, 2023 (JP) 2023-015435

(51) Int. Cl. C09J 4/00; C09J 5/00; C09J 133/14

(52) U.S. Cl. CPC C09J 4/00; C09J 5/00; C09J 133/14

(57) ABSTRACT

An adhesive is an adhesive for adhering an adherence target body, and includes a polymerization initiator contained in a composition including a hydrophilic urethane acrylate and a hydrophilic acrylate in a state in which at least one of the hydrophilic urethane acrylate or the hydrophilic acrylate is in a state of an aqueous solution. The adherence target body is able to be peeled off by exposing the adhesive to water after polymerization. The polymerization initiator is a photo-polymerization initiator. The adhesive contains 1 to 14 wt % of the hydrophilic urethane acrylate, 30 to 90 wt % of the hydrophilic acrylate, 4 to 56 wt % of water, and 0.5 to 3 wt % of the photo-polymerization initiator.

### BACKGROUND OF THE INVENTION

### Field of the Invention

The present invention relates to an adhesive and an adhering method.

### Description of the Related Art

In a manufacturing process of semiconductor devices and electronic devices, a workpiece may be subjected to observation or measurement before or after processing thereof by a processing apparatus such as a dicing saw, a grinding apparatus, and a polishing apparatus.

In a case where the workpiece is small, the workpiece may tentatively be fixed to a plate such as a silicon wafer and a glass plate, for example, by use of a hot melt type adhesive, for example (see, for example, Japanese Patent Laid-open No. 2022-65181), and observation or measurement is conducted by use of an observation apparatus or a measuring apparatus.

### SUMMARY OF THE INVENTION

However, the hot melt type adhesive should be subjected to fixing and peeling-off operations on a hot plate, and after the peeling-off, the adhesive deposited on the workpiece should be cleaned by ultrasonic cleaning or the like. This is laborious, and an improvement has been requested. In this way, the hot melt type adhesive having been used hitherto has a problem that it is laborious to achieve peeling-off.

Therefore, an object of the present invention is to provide an adhesive and an adhering method that can suppress the labor needed for peeling-off.

In accordance with an aspect of the present invention, there is provided an adhesive for adhering an adherence target body. The adhesive includes a polymerization initiator contained in a composition including a hydrophilic urethane acrylate and a hydrophilic acrylate in a state in which at least one of the hydrophilic urethane acrylate or the hydrophilic acrylate is in a state of an aqueous solution. The adherence target body is able to be peeled off by exposing the adhesive to water after polymerization.

Preferably, the polymerization initiator is a photo-polymerization initiator.

In accordance with another aspect of the present invention, there is provided an adhering method for adhering a first adherence target body and a second adherence target body to each other. The adhering method includes an adhesive preparing step of preparing an adhesive including a polymerization initiator contained in a composition including a hydrophilic urethane acrylate and a hydrophilic acrylate in a state in which at least one of the urethane acrylate or the acrylate is in a state of an aqueous solution, an adhering step of starting polymerization of the adhesive in a state of being interposed between the first adherence target body and the second adherence target body, to thereby adhere the first adherence target body and the second adherence target body to each other, and a detaching step of supplying water to the adhesive present between the first adherence target body and the second adherence target body, to thereby separate the first adherence target body and the second adherence target body from each other.

The present invention produces an effect that the labor needed for peeling-off can be suppressed.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is a sectional view schematically depicting a state in which an adhesive according to a first embodiment is accommodated in a container;

FIG. 2 is a perspective view depicting an example of a first adherence target body which is to be adhered by an adhering method according to the first embodiment;

FIG. 3 is a perspective view depicting an example of a second adherence target body which is to be adhered by the adhering method according to the first embodiment;

FIG. 4 is a flow chart depicting the flow of the adhering method according to the first embodiment;

FIG. 5 is a perspective view schematically depicting a state in which the adhesive is applied to the first adherence target body in an adhering step of the adhering method depicted in FIG. 4;

FIG. 6 is a sectional view schematically depicting a state in which a part of the second adherence target body is pressed into the adhesive depicted in FIG. 5;

FIG. 7 is a sectional view schematically depicting a state in which water is supplied to the adhesive with which the adherence target bodies have been fixed to each other, in a detaching step of the adhering method depicted in FIG. 4; and

FIG. 8 is a sectional view schematically depicting a state in which the second adherence target body has been separated from the first adherence target body, the adherence target bodies being depicted in FIG. 7.

### DETAILED DESCRIPTION OF THE PREFERRED EMBODIMENT

An embodiment of the present invention will be described in detail below with reference to the drawings. The present invention is not to be limited by the contents of the following description of the embodiment. In addition, the constituent elements described below include those which can easily be conceived of by a person skilled in the art and those which are substantially the same. Further, the configurations described below can be combined with one another as required. Besides, various omissions, replacements, or modifications of the configurations are possible within such ranges as not to depart from the gist of the invention.

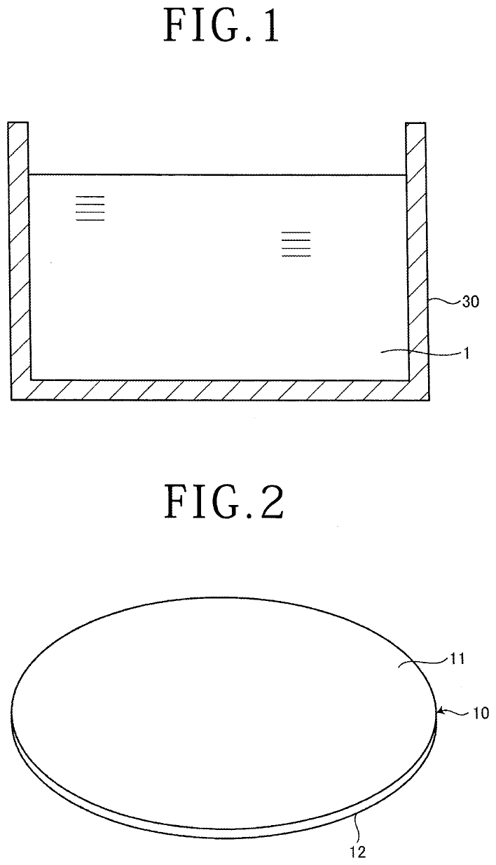

An adhesive according to a first embodiment of the present invention will be described with reference to the drawings. FIG. 1 is a sectional view schematically depicting a state in which the adhesive according to the first embodiment is accommodated in a container.

An adhesive 1 depicted in FIG. 1 according to the first embodiment is for adhering an adherence target body. The adhesive 1 includes an aqueous urethane acrylate (in the present invention, also called an aqueous urethane acrylate solution), a hydrophilic acrylate, and a photo-polymerization initiator which is a polymerization initiator, and the adhesive 1 is liquid. In addition, in the first embodiment, the adhesive 1 may include a hydrophilic urethane acrylate and an aqueous acrylate solution, or may include an aqueous urethane acrylate and an aqueous acrylate solution.

In this way, in the present invention, it is sufficient if the adhesive 1 contains the photo-polymerization initiator as a polymerization initiator in a composition including the hydrophilic urethane acrylate and the hydrophilic acrylate in a state in which at least one of the hydrophilic urethane acrylate or the hydrophilic acrylate is in the state of an aqueous solution. In addition, in the first embodiment, the adhesive 1 contains, as a polymerization initiator, the photo-polymerization initiator that starts polymerization to cure the adhesive 1 when irradiated with ultraviolet (UV) rays. However, in the present invention, the adhesive 1 may contain a polymerization initiator other than the photo-polymerization initiator.

The hydrophilic urethan acrylate is a urethane acrylate having what is generally called a hydrophilic group. As the hydrophilic urethane acrylate, for example, KRM2000 or EBECRYL 4587 (made by DAICEL-ALLNEX LTD.), UAW-1000W20 (made by Kyoeisha Chemical Co., Ltd.), UV-W300 or UT-7119 (made by Mitsubishi Chemical Corporation), 8WX-022A or 8WX-030 (made by Taisei Fine Chemical Co., Ltd.), or UA-7100 or UA-W2A (made by SHIN-NAKAMURA CHEMICAL Co., Ltd.) is used.

The hydrophilic acrylate is an acrylate having what is generally called a hydrophilic group, and is selected from, for example, hydroxymethyl methacrylate, hydroxyethyl acrylate, hydroxypropyl methacrylate, hydroxypropyl acrylate, vinyl pyrrolidone, ethoxyethoxyethyl methacrylate, ethoxyethoxyethyl acrylate, ethoxyethyl methacrylate, ethoxyethyl acrylate, methoxyethyl methacrylate, methoxyethyl acrylate, 1,3-butylene glycol dimethacrylate, ethylene glycol dimethacrylate, polyethylene glycol methacrylate, polyethylene glycol dimethacrylate, polyethylene glycol acrylate, poly(ethylene glycol) methyl ether methacrylate, polyethylene glycol methyl ether acrylate, glycidyl methacrylate, glycidyl acrylate, acrylic acid, methacrylic acid, 2-(trifluoromethyl)acrylic acid, phenylacrylic acid, acrylamide, methacrylamide, N-methylol acrylamide, N-methylol methacrylamide, bisphenol-A-glycelol tetraacrylate, bisphenol-A-glycelol diacrylate, bisphenol-A-ethylene oxydiacrylate, pentaerythritol triacrylate, and derivatives or mixtures of the above-mentioned substances.

As the photo-polymerization initiator as a polymerization initiator, there is used, for example, Omnirad 2959 (made by IGM Resins B.V.).

The above-described adhesive 1 is cured when irradiated with UV rays which are light, and, when it is exposed to water after curing, it is swollen by containing water. The above-described adhesive 1 is rapidly swollen if the amount of the hydrophilic acrylate is large, and the rate of swelling is lowered when the amount of the hydrophilic urethane acrylate increases, but the adhesive 1 is not completely cured if the amount of the hydrophilic acrylate increases excessively.

Note that the adhesive 1 contains the photo-polymerization initiator as a polymerization initiator in the composition including the hydrophilic urethane acrylate and the hydrophilic acrylate in a state in which at least one of the hydrophilic urethane acrylate or the hydrophilic acrylate is in the state of an aqueous solution, because if the composition includes the hydrophilic urethane acrylate singly or the hydrophilic acrylate singly, the adhesive 1 is not cured (half curing) even when irradiated with UV rays as light, whereas the adhesive 1 is cured when irradiated with UV rays as light if the composition includes both the hydrophilic urethane acrylate and the hydrophilic acrylate.

In addition, the adhesive 1 contains the photo-polymerization initiator as a polymerization initiator in the composition including the hydrophilic urethane acrylate and the hydrophilic acrylate in a state in which at least one of the hydrophilic urethane acrylate or the hydrophilic acrylate is in the state of an aqueous solution, because the adhesive 1 is not swollen if the composition includes the hydrophilic acrylate singly, the adhesive 1 is not swollen if the aqueous urethane acrylate is absent, and the swelling after curing does not occur if neither of the hydrophilic urethane acrylate and the hydrophilic acrylate is in the state of an aqueous solution. It is presumed that the reason lies in that the swelling occurs in a state in which at least one of the hydrophilic urethane acrylate or the hydrophilic acrylate is in the state of an aqueous solution.

The above-described adhesive 1 is cured when irradiated with UV rays as light and is swollen when exposed to water after the curing, if, for example, the amount of the hydrophilic urethane acrylate is 1 to 14 wt %, the amount of the hydrophilic acrylate is 30 to 90 wt %, the amount of water is 4 to 56 wt %, and the amount of the photo-polymerization initiator is 0.5 to 3 wt %.

In addition, if, for example, the amount of the hydrophilic urethane acrylate is 1.98 to 3.96 wt %, the amount of the hydrophilic acrylate is 79.21 to 89.11 wt %, the amount of water is 7.92 to 15.84 wt %, and the amount of the photo-polymerization initiator is 0.99 to 1.00 wt %, the swelling time of the adhesive 1 when exposed to water after curing is shorter than that in a case where the above-mentioned substances are present in the above-mentioned proportions.

In the first embodiment, the adhesive 1 contains, for example, the photo-polymerization initiator in the composition including the aqueous urethane acrylate of a concentration of 20% and methoxypolyethylene glycol acrylate which is a hydrophilic acrylate, and the proportions of the components are adjusted to be the above-described proportions.

Note that, while an example in which the adhesive 1 is accommodated in a container 30 opening on the upper side is described in FIG. 1, the container 30 in which to accommodate the adhesive 1 is not limited to that depicted in FIG. 1, in the present invention.

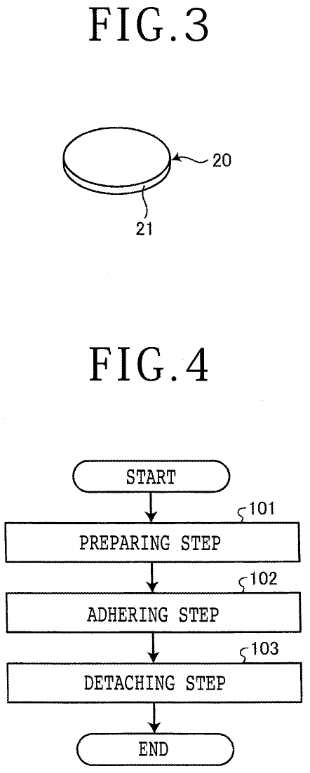

Next, the adhering method according to the first embodiment will be described with reference to the drawings. FIG. 2 is a perspective view depicting an example of a first adherence target body which is to be adhered by the adhering method according to the first embodiment. FIG. 3 is a perspective view depicting an example of a second adherence target body which is to be adhered by the adhering method according to the first embodiment. FIG. 4 is a flow chart depicting the flow of the adhering method according to the first embodiment.

The adhering method according to the first embodiment is an adhering method for adhering the first adherence target body (corresponding to the adherence target body) 10 depicted in FIG. 2 and the second adherence target body (corresponding to the adherence target body) 20 depicted in FIG. 3. The first adherence target body 10 depicted in FIG. 2 which is to be adhered by the adhering method according to the first embodiment is formed of, for example, glass and is a disk-shaped glass plate having a fixed thickness.

The second adherence target body 20 depicted in FIG. 3 which is to be adhered by the adhering method according to the first embodiment is configured by hollowing out a part of a silicon wafer, and is a wafer formed of disk-shaped silicon having a fixed thickness. In the first embodiment, the outside diameter of the second adherence target body 20 is smaller than the outside diameter of the first adherence target body 10. In addition, in the embodiment, after the second adherence target body 20 is adhered and fixed to the first adherence target body 10, the state of a circumferential surface 21 of the second adherence target body 20 is observed by a microscope or the like.

As depicted in FIG. 4, the adhering method according to the embodiment includes a preparing step 101, an adhering step 102, and a detaching step 103.

The preparing step 101 is an adhesive preparing step for preparing the adhesive 1. In the first embodiment, the adhesive 1, the first adherence target body 10, and the second adherence target body 20 are prepared in the preparing step 101.

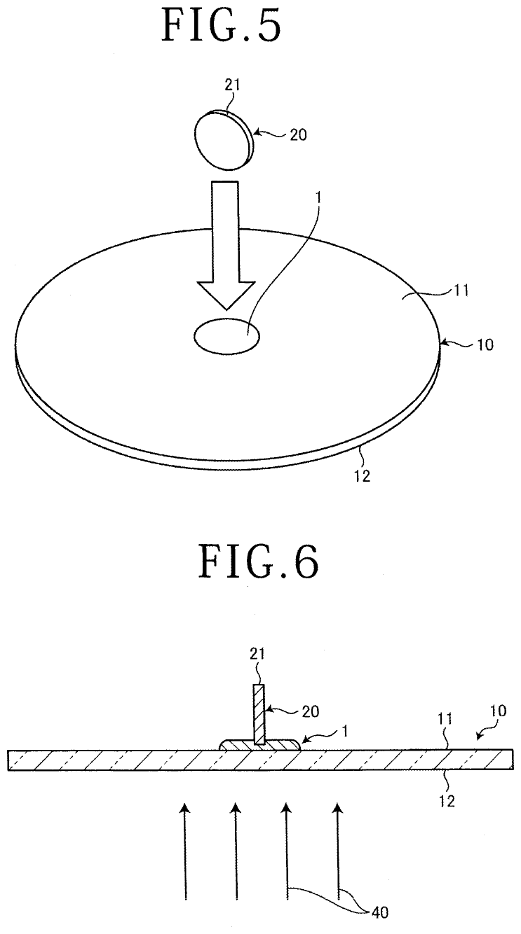

FIG. 5 is a perspective view schematically depicting a state in which the adhesive has been applied to the first adherence target body in the adhering step of the adhering method depicted in FIG. 4. FIG. 6 is a sectional view schematically depicting a state in which a part of the second adherence target body is pressed into the adhesive depicted in FIG. 5. The adhering step 102 is a step of starting polymerization of the adhesive 1 in a state in which the adhesive 1 is interposed between the first adherence target body 10 and the second adherence target body 20, to thereby adhere the first adherence target body 10 and the second adherence target body 20 to each other.

In the first embodiment, in the adhering step 102, as depicted in FIG. 5, the adhesive 1 is applied to the center of a front surface 11 of the first adherence target body 10. In the first embodiment, in the adhering step 102, as depicted in FIG. 6, a part of a peripheral edge part of the second adherence target body 20 is inserted into the adhesive 1 present on the center of the front surface 11 of the first adherence target body 10, and the adhesive 1 is irradiated with UV rays 40 which are light.

In the first embodiment, in the adhering step 102, a back surface 12 side of the first adherence target body 10 is irradiated with the UV rays 40, and the UV rays 40 are caused to penetrate the first adherence target body 10 and be applied to the adhesive 1, whereby polymerization of the adhesive 1 is started in a state in which the adhesive 1 is interposed between the first adherence target body 10 and the second adherence target body 20. In the first embodiment, in the adhering step 102, the UV rays 40 are applied to the adhesive 1 for a predetermined time, to cure the adhesive 1.

In the first embodiment, in the adhering step 102, in a state in which the second adherence target body 20 is as if erected from the front surface 11 of the first adherence target body 10, the adherence target bodies 10 and 20 are adhered to each other with the adhesive 1, whereby the adherence target bodies 10 and 20 are fixed to each other. In the first embodiment, the adherence target bodies 10 and 20 are fixed to each other, and the state of the circumferential surface 21 of the second adherence target body 20 is observed by an unillustrated microscope.

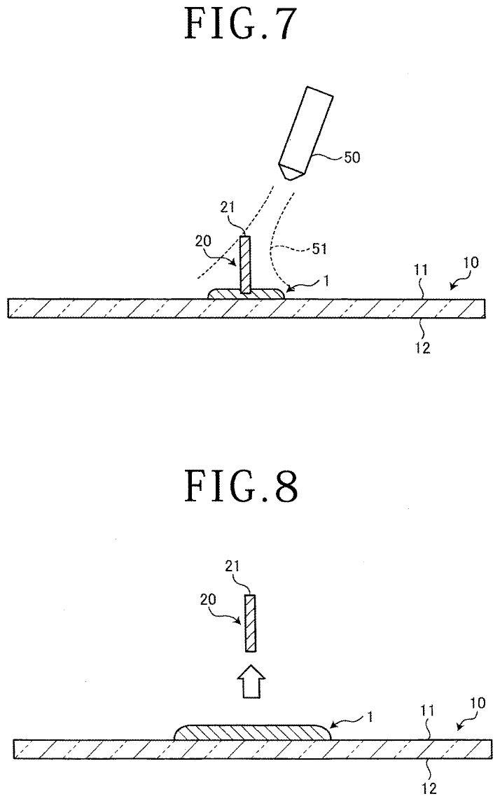

FIG. 7 is a sectional view schematically depicting a state in which water is supplied to the adhesive with which the adherence target bodies have been fixed to each other, in the detaching step of the adhering method depicted in FIG. 4. FIG. 8 is a sectional view schematically depicting a state in which the second adherence target body has been separated from the first adherence target body, the adherence target bodies being depicted in FIG. 7. The detaching step is a step of supplying water 51 to the adhesive 1 present between the first adherence target body 10 and the second adherence target body 20, to thereby separate the first adherence target body 10 and the second adherence target body 20 from each other.

In the first embodiment, in the detaching step 103, as depicted in FIG. 7, the water 51 is supplied from a supply nozzle 50 to the adhesive 1 with which the adherence target bodies 10 and 20 have been fixed to each other. Then, the adhesive 1 absorbs the water 51 and is swollen. In this way, the adhesive 1 is swollen when exposed to the water 51 after curing, that is, after polymerization. In the first embodiment, in the detaching step 103, when a predetermined time has elapsed after the adhesive 1 with which the adherence target bodies 10 and 20 have been fixed to each other is supplied with the water 51 from the supply nozzle 50 and when the adhesive 1 is swollen, the second adherence target body 20 is separated from the front surface 11 of the first adherence target body 10, whereby the adherence target bodies 10 and 20 are separated from each other, as depicted in FIG. 8. In this way, the adhesive 1 is swollen when exposed to the water 51 after polymerization, that is, after curing, whereby the adherence target bodies 10 and 20 can be peeled off from each other.

As has been described above, the adhesive 1 according to the first embodiment is swollen when exposed to water 51 after curing, that is, after polymerization. Hence, by exposing the adhesive 1 to the water 51 after curing, that is, after polymerization, the adherence target bodies 10 and 20 can easily be separated, that is, be peeled off from each other.

As a result, the adhesive 1 according to the first embodiment produces an effect that the labor needed for peeling-off of the adherence target bodies from each other can be suppressed.

In addition, the adhering method according to the first embodiment includes fixation by adhesion of the adherence target bodies 10 and 20 to each other with the adhesive 1, and, hence, produces an effect that the adherence target bodies 10 and 20 fixed to each other can easily be separated, that is, be peeled off from each other, and that the labor needed for peeling-off of the adherence target bodies 10 and 20 from each other can be suppressed.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. An adhesive for adhering an adherence target body, the adhesive comprising:
a polymerization initiator contained in a composition including a hydrophilic urethane acrylate and a hydrophilic acrylate in a state in which at least one of the hydrophilic urethane acrylate or the hydrophilic acrylate is in a state of an aqueous solution,
wherein the adherence target body is able to be peeled off by exposing the adhesive to water after polymerization.

2. The adhesive according to claim 1, wherein the polymerization initiator is a photo-polymerization initiator.

3. An adhering method for adhering a first adherence target body and a second adherence target body to each other, the adhering method comprising:
an adhesive preparing step of preparing an adhesive including a polymerization initiator contained in a composition including a hydrophilic urethane acrylate and a hydrophilic acrylate in a state in which at least one of the urethane acrylate or the acrylate is in a state of an aqueous solution;
an adhering step of starting polymerization of the adhesive in a state of being interposed between the first adherence target body and the second adherence target body, to thereby adhere the first adherence target body and the second adherence target body to each other; and
a detaching step of supplying water to the adhesive present between the first adherence target body and the second adherence target body, to thereby separate the first adherence target body and the second adherence target body from each other.
